(19) United States
(12) Patent Application Publication
(10) Pub. No.: US 2022/0145905 A1
(43) Pub. Date: May 12, 2022

(54) Systems And Methods For Increasing The Efficiency Of Axial Ducted Fans

(71) Applicant: Dileep Dasari, Visakhapatnam (IN)

(72) Inventor: Dileep Dasari, Visakhapatnam (IN)

(21) Appl. No.: 17/599,558

(22) PCT Filed: Aug. 8, 2019
(86) PCT No.: PCT/IN2019/050581

§ 371 Date: Sep. 29, 2021

(30) Foreign Application Priority Data
Apr. 1, 2019 (IN) 201941013165

(51) Int. Cl. F04D 29/56; F02K 3/06

(52) U.S. Cl. CPC F04D 29/563; F05D 2270/20; F05D 2240/126; F02K 3/06

(57) ABSTRACT

A system 100 for increasing the efficiency of an axial ducted fan 105 includes, a duct 110 for enclosing the axial ducted fan 105, wherein the axial ducted fan 105 is operationally mounted inside the duct 110. In use, the system 100 further includes, a shaft 115 operably connected to the axial ducted fan 105 for facilitating rotation of the axial ducted fan 105 inside the duct 110; and, a static fan 120 operably positioned parallel to the axial ducted fan 105. In use, the static fan 120 includes same number of blades as the axial ducted fan 105. The system 100 further includes a propulsion efficiency improvement mechanism 125 operably positioned inside the duct 110 for controlling, (a) a position of the static fan 120, and, (b) speed of rotation of the axial ducted fan 105.

### FIELD OF THE INVENTION

Embodiments of the present invention generally relate to the field of axial fans, and, more particularly, to systems and methods for increasing the efficiency of axial ducted fans.

### BACKGROUND OF THE INVENTION

Generally, various systems require movement of high volume of air through the usage of axial ducted fans in machines. Such systems are commonly employed across multiple applications, such as, for example, but not limited to, Turbofan Engines, Computer Cooling Fans, and the like.

As it is well known, a ducted fan is a propulsion arrangement whereby a mechanical fan, which is a type of propeller, is mounted within a cylindrical shroud or duct. In use, axial ducted fans are employed across various industrial and mechanical applications, such as, for example, but not limited to, Turbofan Engines, Computer cooling fans, and the like.

However, as it is duly experienced across such applications, axial fans are not completely efficient. For example, Turbofan engines have a large fan in the front which provides most of the thrust and draws in the air into the core. Since this fan is not fully efficient, the overall propulsive efficiency of the turbofan engine is also affected.

Currently, there are practically no available technologies or methods or systems to increase the efficiency of the ducted fans/axial fans. One of the known methods involve improving the fan/blade design, which does not fully improve the efficiency of the ducted fans/axial fans.

Accordingly, there remains a need in the art to develop new systems and methods that increase the efficiency of axial ducted fans.

### SUMMARY OF THE INVENTION

In accordance with an embodiment of the present invention, a system for increasing the efficiency of an axial ducted fan includes, a duct for enclosing the axial ducted fan, wherein the axial ducted fan is operationally mounted inside the duct. In use, the system further includes, a shaft operably connected to the axial ducted fan for facilitating rotation of the axial ducted fan inside the duct; and, a static fan operably positioned parallel to the axial ducted fan. In use, the static fan includes same number of blades as the axial ducted fan.

In accordance with an embodiment of the present invention, the system further includes a propulsion efficiency improvement mechanism operably positioned inside the duct for controlling, (a) a position of the static fan, and, (b) speed of rotation of the axial ducted fan. In operation, the propulsion efficiency improvement mechanism is configured to control the static fan in a manner such that airflow of the static fan is exactly same as an output airflow of the axial ducted fan.

The embodiments of the present disclosure have several features, no single one of which is solely responsible for their desirable attributes. Without limiting the scope of the present embodiments as expressed by the claims that follow, their more prominent features will now be discussed briefly. After considering this discussion, and particularly after reading the section entitled “Detailed Description”, one will understand how the features of the present embodiments provide advantages, which include providing systems and methods for increasing the efficiency of axial ducted fans.

### BRIEF DESCRIPTION OF THE DRAWINGS

FIG. 1A, FIG. 1B, and FIG. 1C illustrate multiple views of a system for increasing the efficiency of axial ducted fans, according to an embodiment of the invention.

### DETAILED DESCRIPTION OF THE INVENTION

Various embodiments of the present invention are disclosed herein below, which relate to systems and methods for increasing the efficiency of axial ducted fans. In operation, embodiments of the present invention are aimed at disclosing usage of a static fan which is similar to the rotating fan, in the duct fan mechanism, to feed the rotating fan with the same type of airflow it would produce at the given RPM/velocity. Subsequently, the mechanism as disclosed herein by way of embodiments of the instant invention is aimed at improving the efficiency of the operating fan. Those of ordinary skills in the art will appreciate that systems and methods as disclosed herein by way of multiple embodiments of the present invention are applicable across various fields, such as, for example, but not limited to, Physics, Fluid Mechanics, Fluid Dynamics, Axial Fans, Turbofan Engines, Ducted fans, Vortex Generator, Propulsion, Propulsive efficiency and the like.

Generally, it is known in the art that conventional propellers produce a vortex type of airflow, which means each blade of the fan experiences a drag force which opposes the direction of rotation. Subsequently, it can be proposed that by placing a similar static fan with the same number of blades in front of the operating fan in the direction of the air intake, the efficiency of the operating fan increases because of the decreased drag on blades of the operating fan due to pre-converting the airflow into a similar vortex flow that'd be produced by the operating fan in an isolated condition. Multiple experiments and simulation results have proven this theory to be correct and therefore, placing a static fan in-front of the operational fan improves the efficiency of the propeller/fan.

Generally, by using conventional methods and technologies, the solutions available in the prior art to improve the efficiency of axial ducted fans are getting saturated. Consequently, embodiments of the present invention are aimed at providing external mechanisms to improve the efficiency of the ducted fans or axial fans beyond the efficiency that is improved by changing blade designs. In use, embodiments of the present invention improve the efficiency of ducted fans by feeding the fans with type of airflow which it would produce at the given speed, through a special Vortex Generating system which mimics the output airflow of fan. Those of ordinary skills in the art will appreciate that systems and methods as disclosed herein are configured to be integrated into new and existing ducted fan designs. Additionally, the instant invention is also proven to improve the efficiency of ducted fans, say a fan used in turbofan engines, by at least 30% approximately.

In accordance with an embodiment of the present invention, a system 100 for increasing the efficiency of an axial ducted fan 105 includes, a duct 110 for enclosing the axial ducted fan 105, wherein the axial ducted fan 105 is operationally mounted inside the duct 110. In use, the system 100 further includes, a shaft 115 operably connected to the axial ducted fan 105 for facilitating rotation of the axial ducted fan 105 inside the duct 110; and, a static fan 120 operably positioned parallel to the axial ducted fan 105. In use, the static fan 120 includes same number of blades as the axial ducted fan 105.

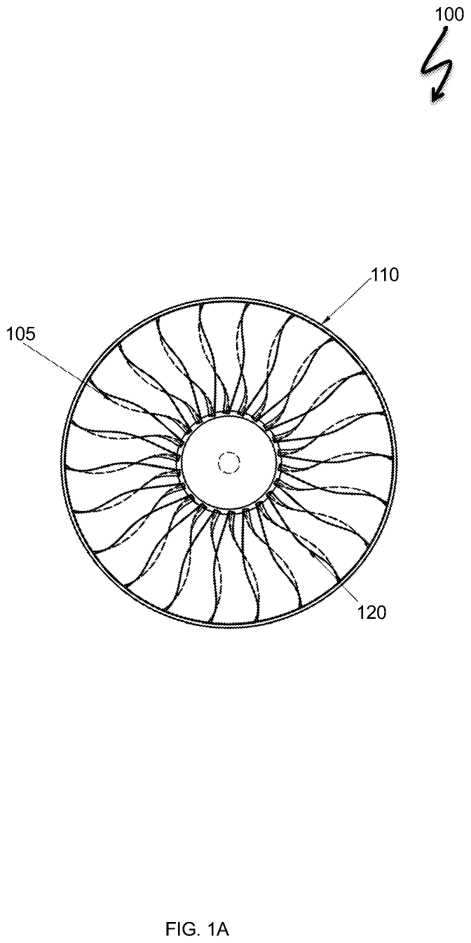

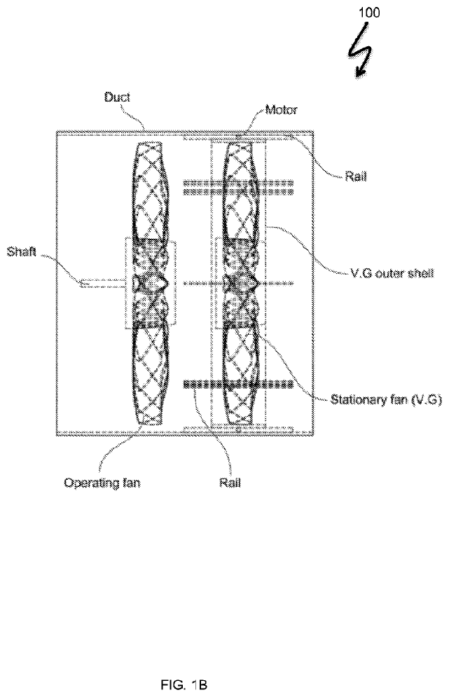

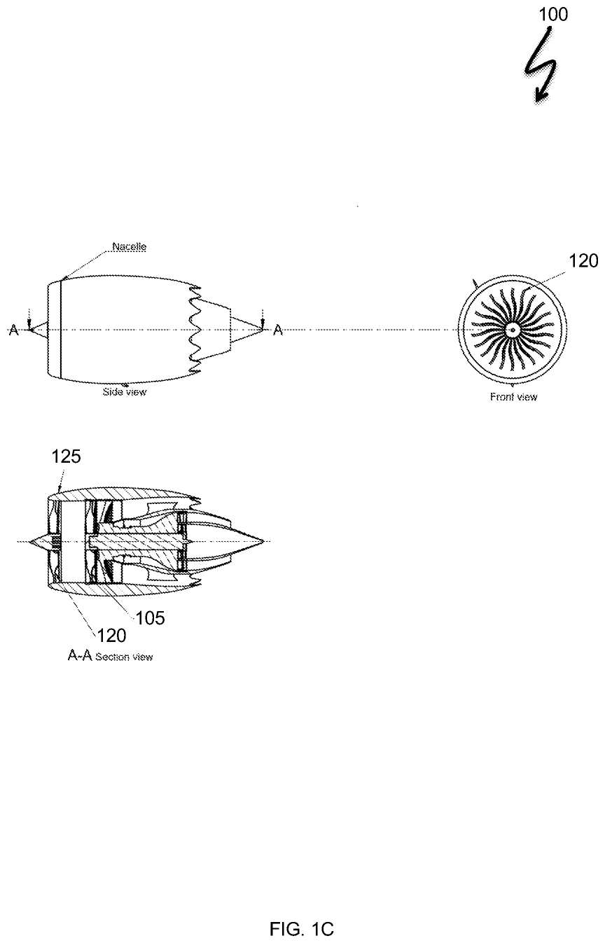

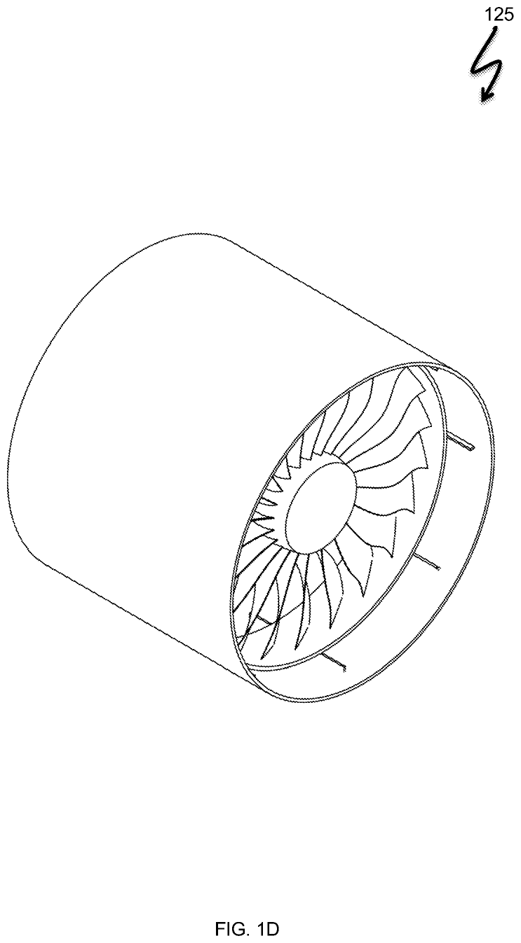

In accordance with an embodiment of the present invention, the system 100 further includes a propulsion efficiency improvement mechanism 125 operably positioned inside the duct 110 for controlling, (a) a position of the static fan 120, and, (b) speed of rotation of the axial ducted fan 105. In operation, the propulsion efficiency improvement mechanism 125 is configured to control the static fan 120 in a manner such that airflow of the static fan 120 is exactly same as an output airflow of the axial ducted fan 105. In use, the propulsion efficiency improvement mechanism 125 includes one or more rails, wherein side view of the rails is illustrated in FIG. 1B and isometric view of the propulsion efficiency improvement mechanism 125 with one or more rails is illustrated in FIG. 1D.

In accordance with an embodiment of the present invention, the static fan 120 is positioned in front of the axial ducted fan 105. In use, the static fan 120 is positioned at a particular distance from the axial ducted fan 105. In further use, such particular distance between the static fan 120 and the axial ducted fan 105 is a shortest distance between the blades of the static fan 120 and the axial ducted fan 105. In addition, such particular distance between the static fan 120 and the axial ducted fan 105 varies from twice the width of the axial ducted fan 105 to thrice the width of the axial ducted fan 105 when the axial ducted fan 105 is rotating at supersonic speeds. Furthermore, such particular distance between the static fan 120 and the axial ducted fan 105 is less than twice the width of the axial ducted fan 105 when the axial ducted fan 105 is rotating at a speed below supersonic speeds.

In accordance with an embodiment of the present invention, the propulsion efficiency improvement mechanism 125 is configured to change the particular distance between the static fan 120 and the axial ducted fan 105 with a horizontal freedom of movement to maintain a higher efficiency at varying speeds of the axial ducted fan 105.

Therefore, as may be seen, various embodiments of the present invention provide significant advantages over prior art, such as, for example, but not limited to, highly improving the efficiency of axial ducted fans, wherein the embodiments of the instant invention are capable of being incorporated into turbofan engines to improve the overall propulsive efficiency of the engine, which subsequently improves the specific fuel consumption of the engine.

As disclosed herein by way of multiple embodiments of the present invention, since the vortex generator or the static fan needs to be at different specific distances from the operational fan at different speeds for maximum improve in efficiency, an inventive mechanism can be incorporated in the nacelle of the turbofan engine which would enable the vortex generator to move to mimic the output flow of the operational fan. In use, such inventive mechanism can be incorporated into any device/system, that uses duct fan mechanism to propel air, to improve its propulsive efficiency.

While there has been shown and described the preferred embodiment of the instant invention it is to be appreciated that the invention may be embodied otherwise than is herein specifically shown and described and that, within the embodiment, certain changes may be made in the form and arrangement of the parts without departing from the underlying ideas or principles of this invention as set forth in the Claims appended herewith. Therefore, the appended claims are to be construed to cover all equivalents falling within the true scope and spirit of the invention.

I claim:

1. A system 100 for increasing the efficiency of an axial ducted fan 105, said system 100 comprising:
a duct 110 for enclosing said axial ducted fan 105, wherein said axial ducted fan 105 is operationally mounted inside said duct 110;
a shaft 115 operably connected to said axial ducted fan 105 for facilitating rotation of said axial ducted fan 105 inside said duct 110;
a static fan 120 operably positioned parallel to said axial ducted fan 105, said static fan 120 comprising same number of blades as said axial ducted fan 105;
a propulsion efficiency improvement mechanism 125 operably positioned inside said duct 110 for controlling, (a) a position of said static fan 120, and, (b) speed of rotation of said axial ducted fan 105;
wherein said propulsion efficiency improvement mechanism 125 is configured to control said static fan 120 in a manner such that airflow of said static fan 120 is exactly same as an output airflow of said axial ducted fan 105.

2. The system 100 as claimed in claim 1, wherein said static fan 120 is positioned in front of said axial ducted fan 105.

3. The system 100 as claimed in claim 1, wherein said static fan 120 is positioned at a particular distance from said axial ducted fan 105.

4. The system 100 as claimed in claim 3, wherein said particular distance between said static fan 120 and said axial ducted fan 105 is a shortest distance between the blades of said static fan 120 and said axial ducted fan 105.

5. The system 100 as claimed in claim 3, wherein said particular distance between said static fan 120 and said axial ducted fan 105 varies from twice the width of said axial ducted fan 105 to thrice the width of said axial ducted fan 105 when said axial ducted fan 105 is rotating at supersonic speeds.

6. The system 100 as claimed in claim 3, wherein said particular distance between said static fan 120 and said axial ducted fan 105 is less than twice the width of said axial ducted fan 105 when said axial ducted fan 105 is rotating at a speed below supersonic speeds.

7. The system 100 as claimed in claim 1, wherein said propulsion efficiency improvement mechanism 125 is configured to change said particular distance between said static fan 120 and said axial ducted fan 105 with a horizontal freedom of movement to maintain a higher efficiency at varying speeds of said axial ducted fan 105.
